(19) United States
(12) Patent Application Publication
(10) Pub. No.: US 2006/0074933 A1
(43) Pub. Date: Apr. 6, 2006

(54) Workflow interaction

(75) Inventors: Dragos Barac, Bellevue, WA (US); Jane T. Kim, Seattle, WA (US); Miladin Pavlicic, Ritterstrasse (DE); Shiraz J. Cupala, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/955,666

(22) Filed: Sep. 30, 2004

(51) Int. Cl. G06F 17/30

(52) U.S. Cl. 707/100

(57) ABSTRACT

Systems and methods enabling interaction with a workflow governing an electronic file and data of that electronic file are described. One of these systems or methods present a dynamically updatable user interface for interacting with a workflow of an electronic file along with the data of the electronic file.

### TECHNICAL FIELD

This invention relates to workflow interaction methods and systems.

### BACKGROUND

Electronic documents are a common way in which people enter, view, and perform tasks related to information. Performing tasks with an electronic document can be structured into a workflow process. This workflow process may dictate, for instance, that one person submit information in an electronic document for someone else's approval after which that person must approve or reject the information.

Assume, for example, that a salesman enters a sale of tires into an electronic sales order document. A workflow for the sales order may dictate that the salesman submit the sales order to his sales manager for approval. The sales manager may then approve or reject the sales order.

But it can be tedious for people like the salesman and sales manager to interact with a workflow process for an electronic document. This is because people often have to independently interact with an electronic document and the workflow for that electronic document. Assume, for example, that the salesman submits the sales order to his sales manager as an attachment to an email. Assume also that the salesman includes a hyperlink in the email that the sales manager can use to interact with the workflow for the sales order. When the sales manager receives the email, she can open the attached sales order, view it to make sure that it is correct, and then close it. Following this, she can select the hyperlink to interact with the workflow. The hyperlink can, for example, connect her to a webpage at which she can select to approve or reject the sales order.

Interacting with the workflow can also be tedious for the salesman. If the salesman wants to know the status of his sales manager's approval, he checks the website to see if she approved. If she has not approved or rejected he can check back later, and so on until he learns that she has approved or rejected the sales order.

### SUMMARY

Systems and methods enabling interaction with a workflow governing an electronic document in conjunction with data of the electronic document are described. These systems and methods can also enable dynamic updating of a user interface that presents a workflow governing an electronic document.

### BRIEF DESCRIPTION OF THE DRAWINGS

FIG. 1 illustrates an exemplary architecture having a workflow server and computing devices communicating across a network.

FIG. 2 sets forth a flow diagram of an exemplary process for enabling joint interaction with an electronic document's data and workflow.

FIG. 3 illustrates a screen shot showing data of an exemplary electronic document and an interface for selecting the electronic document's workflow.

FIG. 4 illustrates an exemplary workflow state for the electronic document of FIG. 3.

FIG. 5 illustrates the screen shot of FIG. 3 and an exemplary workflow user interface.

FIG. 6 illustrates the screen shot of FIG. 3 and another exemplary workflow user interface.

FIG. 7 illustrates the screen shot of FIG. 3 and the exemplary workflow user interface of FIG. 6 after being updated.

FIG. 8 illustrates the screen shot of FIG. 3 and the exemplary workflow user interface of FIG. 5 after being updated.

The same numbers are used throughout the disclosure and figures to reference like components and features.

### DETAILED DESCRIPTION

Overview

Systems and methods (“tools”) described below may jointly enable interaction with a workflow governing an electronic file and data of that electronic file. By so doing, a user may interact with data of an electronic file, such as viewing the data, while also performing a workflow task for that electronic file, such as approving it.

In one embodiment, for instance, the tools present a dynamically updatable user interface for interacting with a workflow of an electronic file along with the data of the electronic file. If a workflow task is performed, such as by the viewer of the user interface or by someone else, the tools may update the user interface to reflect the performance of that task.

Exemplary Architecture

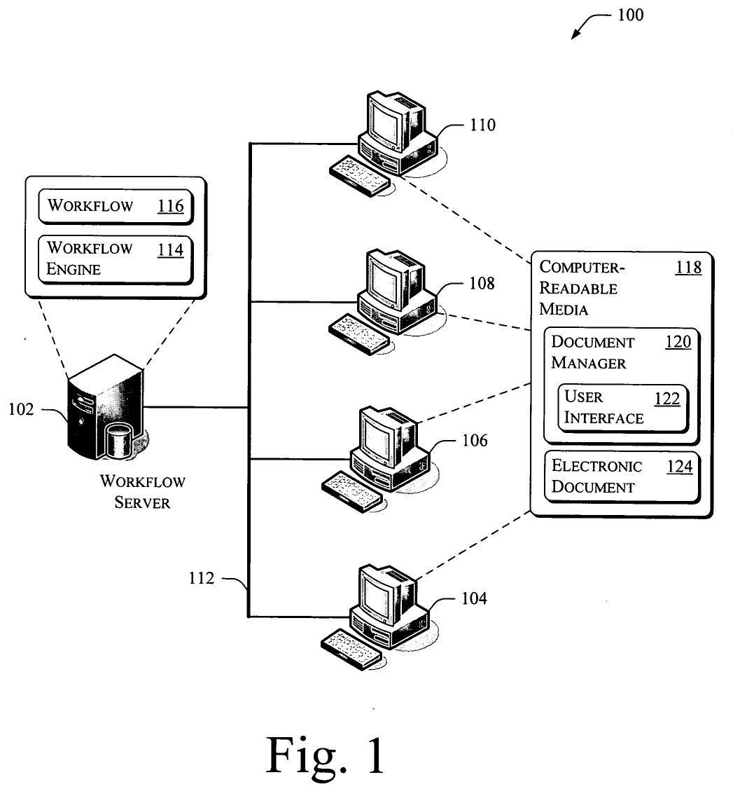

Referring to FIG. 1, an exemplary architecture 100 is shown having a workflow server 102, computing devices 104, 106, 108, and 110, and a network 112. The computing devices and the workflow server can communicate via the network, which may be an intranet, the Internet, a wireless network, or another communication network.

The workflow server comprises a workflow engine 114 and a workflow 116. The workflow comprises workflow process rules, tasks, and related information for electronic files. The workflow engine is capable of providing information about the workflow to the computing devices. The workflow engine can comprise or interact with applications capable of managing workflow processes, such as Microsoft® BizTalk™. Each of the computing devices can access or comprise computer-readable media 118, such as by each computing device having the computer-readable media on local memory. This computer-readable media comprises a document manager 120 having a user interface 122 and an electronic document 124. The electronic document is an exemplary electronic file associated with a workflow. This exemplary electronic file can be hierarchically structured and written using a tag-based language, such as eXtensible Markup Language (XML), though other structures and languages may be used. The electronic document's workflow process is governed by the workflow 116. Each of the workflow, workflow engine, document manager, user interface, and electronic document can operate separately or jointly and be located at same or disparate locations.

Architecture 100 and its components are shown to aid in discussing the tools but are not intended to limit their scope or applicability.

Enabling Workflow Interaction

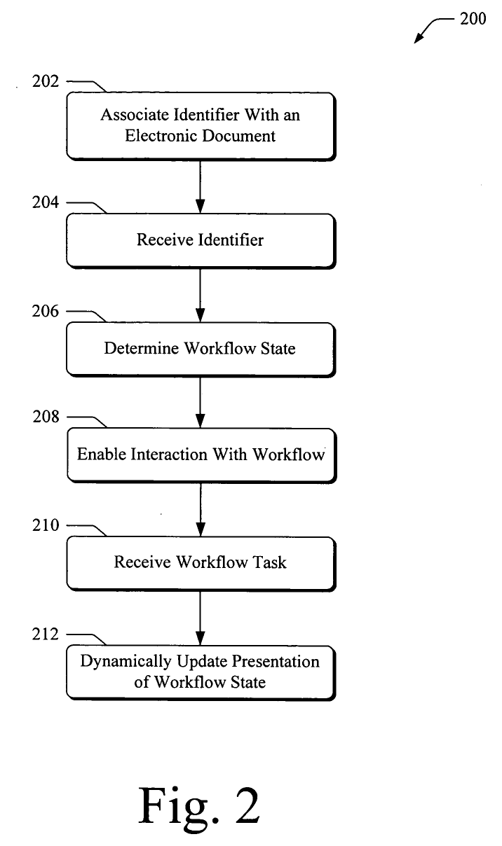

Referring to FIG. 2, an exemplary process 200 for enabling interaction with a workflow governing an electronic file along with data of that electronic file is shown. The process 200 is illustrated as a series of blocks representing individual operations or acts performed by components of architecture 100. This process may be implemented in any suitable hardware, software, firmware, or combination thereof. In the case of software and firmware, this process represent sets of operations implemented as computer-executable instructions.

At block 202, document manager 120 associates an identifier with electronic document 124, such as by adding the identifier to the electronic document. The identifier comprises information sufficient to enable determination of a workflow state of the electronic document in a workflow governing the electronic document. A workflow state of an electronic file in a workflow may, for example, include tasks that have been or are requested to be performed. If an electronic file has been requested to be approved by two managers, for instance, the state of the electronic file could comprise: (i) request for approval by two managers; (ii) approval by one of the managers is complete; and (iii) approval by the other manager is pending.

At block 204, document manager 120 receives an identifier associated with electronic document 124. The document manager can receive this identifier in various ways. In one embodiment, the document manager receives the identifier automatically. If a user opens the electronic document, for instance, the document manager can automatically receive or be prompted to perform actions to receive the identifier.

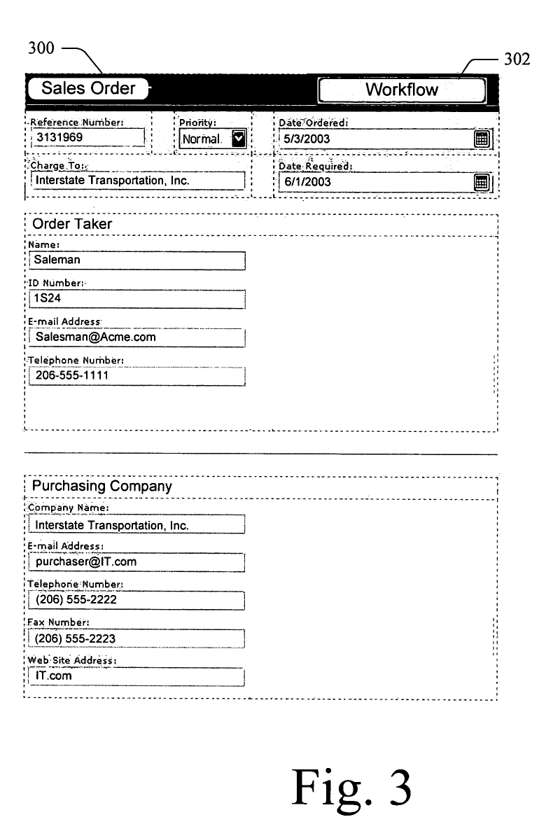

In another embodiment, a user interface associated with the electronic document enables a user to request interaction with a workflow for the electronic document. In this case the document manager receives the identifier responsive to a user's request. An exemplary embodiment is illustrated in FIG. 3, which shows an exemplary screen shot 300 of electronic document 124 (here a “Sales Order”) with a workflow interface selector 302. Here the electronic document's user interface enables a user to request interaction with a workflow that governs the electronic document.

At block 206, document manager 120 determines a workflow state of electronic document 124. The document manager can do so responsive to receiving an identifier for the electronic document, such as set forth at block 204. In one embodiment, the identifier indicates an identity of the electronic document. With this identity, the document manager can determine which workflow governs the electronic document and a workflow state of the electronic document in the workflow. This identity may enable the document manager to differentiate between multiple electronic documents governed by a workflow each of which may have different workflow states.

The document manager may determine a workflow state for the electronic document in conjunction with workflow engine 114. In this case the document manager sends the identifier (or an alteration of the identifier that is understandable by workflow engine 114) to the workflow engine. The workflow engine can, based on this identifier, determine which of multiple workflows the electronic document is governed by. In the architecture 100 only workflow 116 is shown, which the workflow engine determines to be the workflow governing the electronic document. The workflow engine then determines the workflow state for the electronic document and sends this to the document manager.

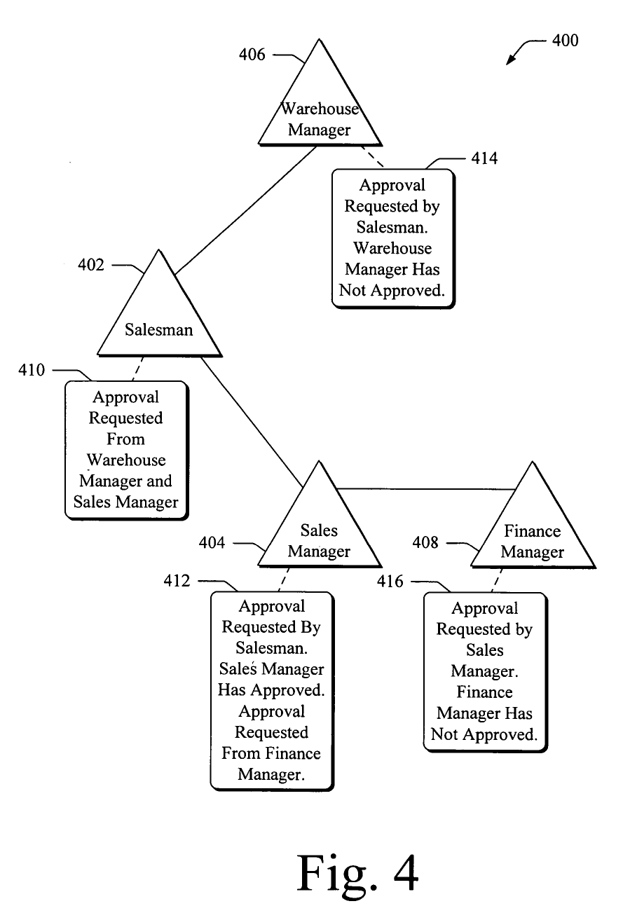

Continuing the illustrated embodiment, FIG. 4 shows a sales order workflow state 400 illustrating an exemplary workflow state for the sales order electronic document shown in FIG. 3. This workflow state is illustrated to aid the reader in understanding how a workflow state can be conceptualized but may not fully illustrate complexities present in many workflow states.

This workflow state is illustrated with a representation for a salesman 402, a sales manager 404, a warehouse manager 406, and a finance manager 408. Each of these persons can act through the four computing devices shown in FIG. 1. Each person is also one that is currently, has been, or can be permitted to perform tasks in the workflow. The states of these tasks in the workflow are shown connected to each person with a dashed line in FIG. 4. These states include: a salesman state 410; a sales manager state 412; a warehouse manager state 414; and a finance manager state 416.

Here the salesman has entered data into the sales order and submitted it for approval by the warehouse manager and the sales manager. The warehouse manager has not approved. The sales manager has approved, but also has requested that his manager (the finance manager) approve the sales order too. The finance manager has not approved.

At block 208, the document manager enables interaction with a workflow, such as by presenting an interface showing the workflow state. With this interface, a user of electronic document 124 can view the present workflow state of the electronic document. The document manager and its user interface 122 can also enable a user to perform workflow tasks through the interface, like approving the electronic document. These interfaces enabling interaction with the workflow can also be associated or presented with the electronic document, such as through a pop-up window or inside the electronic document itself.

In one embodiment, the document manager tailors the workflow state to the user that is viewing electronic document 124. This can simplify and make more user-friendly a user's interaction with a workflow.

The document manager can tailor the workflow state by presenting information pertinent to a user. The document manager can determine what information is pertinent by filtering out parts of the workflow state that are not directly before or after the user's current task. The document manager can also send a user identifier to workflow engine 114. With this user identifier, the workflow engine can return to the document manager a set of tasks associated with the user, such as those performed by the user or that are permitted to be performed by the user. The document manager analyzes this information to tailor the information presented to the user, either as part of block 208 or previously as part of block 206.

This information received by the document manager, whether the full workflow state for the electronic file or information associated with a particular user, can be tailored by the document manager into sections. These sections represent types of information and actions likely to be pertinent to a user, such as sections directed to: tasks that the user can perform, like initiating a request for approval from other people; general information about the workflow, like the workflow being directed to approval of the electronic file; status of tasks, like whether or not other users have approved; and ways in which a task requested of the user can be responded to, like rejecting, approving, delegating, or escalating a request for approval.

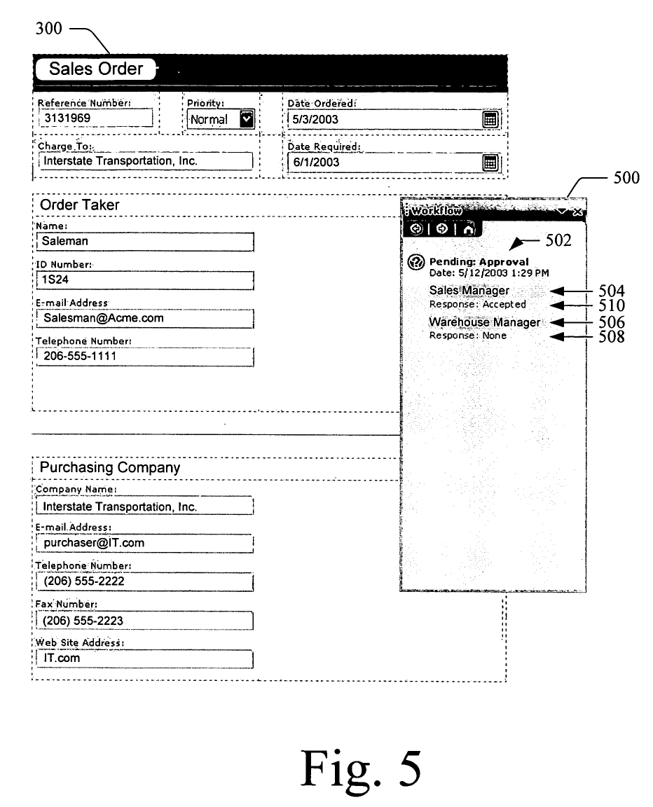

An exemplary tailored, workflow user interface is shown in FIG. 5, which includes a screen shot 300 of FIG. 3 and an exemplary workflow user interface 500. This workflow user interface is tailored to salesman 402 of the ongoing example. The interface enables the salesman to see relevant parts of the workflow state, including that he has requested approval (enumerated at 502) from sales manager 404 and warehouse manager 406 (enumerated at 504 and 506), the warehouse manager has not approved the sales order (enumerated at 508 and having text of: “Response: None”), and the sales manager has approved (enumerated at 510 and having text of: “Response: Accepted”). This workflow user interface for the salesman does not enable tasks to be performed by the salesman at this stage, though the approval previously requested by the salesman can be enabled through this user interface. This workflow user interface is tailored to refrain from showing information not necessarily pertinent to the salesman, in this case that the sales manager has requested approval from the finance manager and that the finance manager has not approved. While the entire workflow state is fairly simple in this example, some workflows may contain many more tasks and persons. Presenting a tailored workflow state of a complex workflow can make interacting with the workflow more intuitive and/or less confusing for a user, such as by showing the user's tasks based on the instance of the document on which the user has an impact.

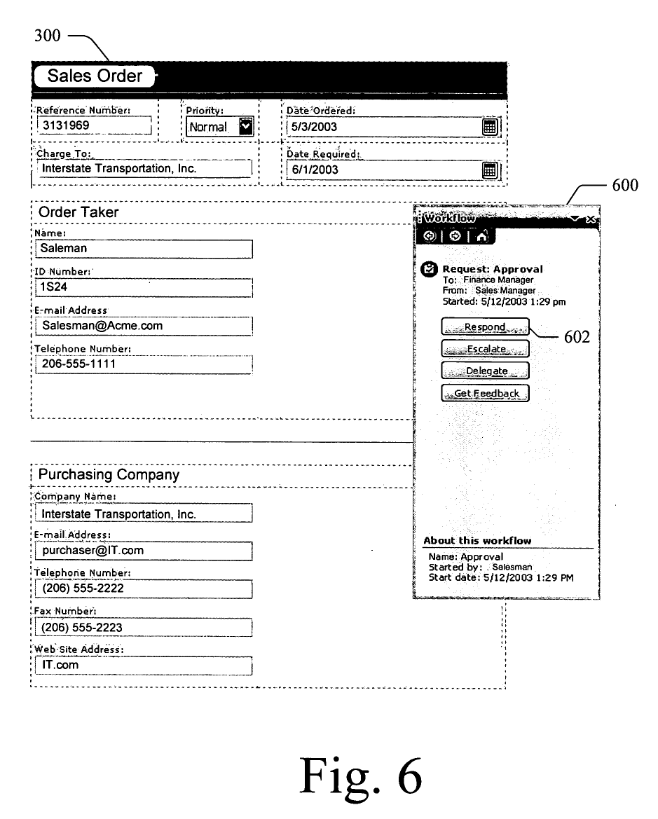

To further illustrate tailoring of user interfaces, a workflow user interface tailored to finance manager 408 is illustrated in FIG. 6. This workflow interface 600 shows the finance manager those parts of the workflow state associated with the finance manager. The workflow interface enables the finance manager to interact with workflow 116 governing electronic document 124 by approving the sales order through selecting a respond button 602. The finance manager can also interact with the data of the electronic document, shown with the screen shot 300 of the sales order, in conjunction with the workflow user interface. This enables the finance manager, for instance, to easily look through data of the sales order and perform workflow tasks for it, in this case by approving it.

At block 210 (FIG. 2), the user interface receives performance of a task. The user interface can send this received task to the document manager or the workflow engine. The document manager or the workflow can then update workflow 116 to reflect a change in the workflow state caused by this task.

Continuing the illustrated embodiment, the finance manager can select to respond to the request for approval by selecting the response button 602 of FIG. 6.

At block 212, the presentation of a workflow state is dynamically updated, such as user interfaces 500 and 600. This update can be performed without user interaction, such as to reflect a change made by workflow engine 114. The workflow engine may change the workflow state without user interaction, such as to reflect a change made because a user has failed to perform a task within a set period of time. An update can also be performed without a user interaction additional to an interaction from a user that causes a change to the workflow state. Here the update can automatically reflect a change to the workflow state caused by a user interacting with the workflow, such as in the illustrated example.

Continuing the illustrated example, the workflow state for the electronic document is updated to reflect the finance manager's approval. This change can be dynamically reflected in a workflow user interface for each person viewing the workflow state. Here, the document manager and its user interface automatically update the tailored user interface 600 of FIG. 6.

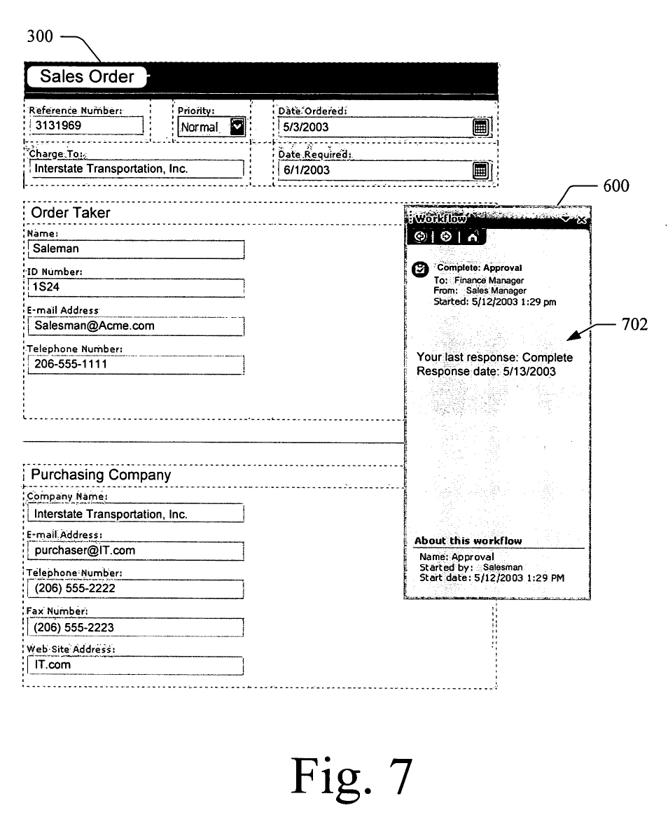

FIG. 7 shows an updated version of user interface 600 tailored to the finance manager. Here the user interface shows that the finance manager has approved, marked at 702.

Similarly, other user interfaces can also be updated. If warehouse manager 406 has also approved, salesman's workflow interface 500 can be updated to show that the approval process is complete. This change to the user interface can be made automatically, such as while the electronic document is being viewed by the salesman or when he opens the electronic document.

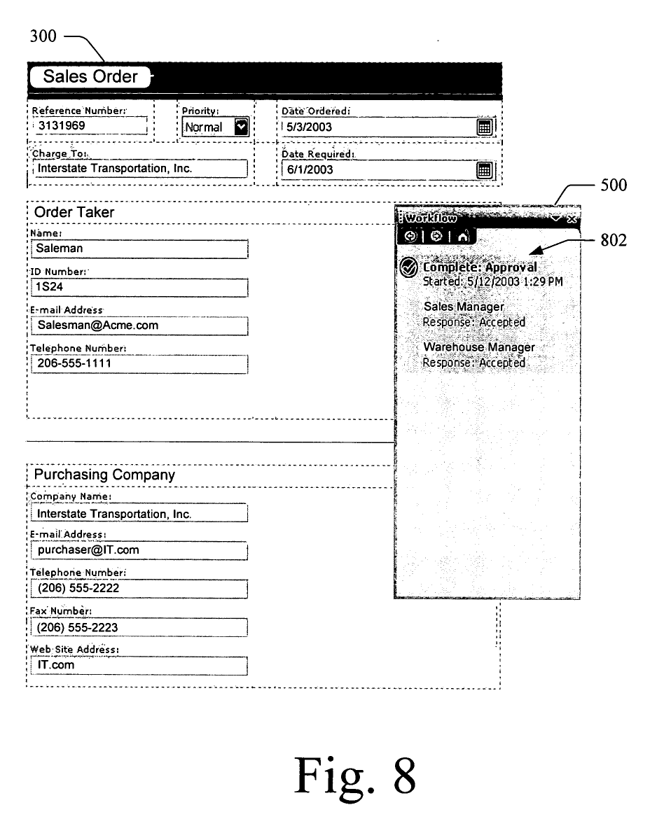

FIG. 8 shows a dynamically updated version of salesman's workflow user interface 500. Here the workflow user interface shows that the approval process is complete, marked at 802.

### CONCLUSION

The above-described tools jointly enable interaction with a workflow governing an electronic file and data of that electronic file. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
determining, responsive to an electronic file being opened, a portion of a workflow state for the electronic file; and
presenting a user interface having a representation of the portion of the workflow state.

2. The method of claim 1, further comprising receiving an identifier associated with and identifying the electronic file and wherein the act of determining is performed responsive to receiving the identifier.

3. The method of claim 1, wherein the act of presenting comprises presenting the user interface in conjunction with a presentation of data of the electronic file.

4. The method of claim 1, wherein the portion comprises workflow tasks associated with a user.

5. The method of claim 1, further comprising updating the user interface responsive to a change in the workflow state.

6. The method of claim 1, wherein the act of presenting the user interface comprises presenting a user interface that enables performance of workflow tasks.

7. One or more computer-readable media having computer-readable instructions for performing the method recited in claim 1.

8. A system comprising means for performing the method recited in claim 1.

9. A method comprising:
receiving an identifier identifying an electronic file;
determining, responsive to receiving the identifier, a workflow governing the electronic file and a workflow state for the electronic file; and
enabling interaction with the workflow that permits altering the workflow state.

10. The method of claim 9, wherein the act of receiving the identifier is performed responsive to the electronic file being opened.

11. The method of claim 9, wherein the act of receiving the identifier is performed responsive to receiving a selection to interact with the workflow through a user interface presenting data of the electronic file.

12. The method of claim 9, wherein the act of determining the workflow state comprises determining the workflow state for the electronic file from among multiple workflow states of other electronic files governed by the workflow.

13. The method of claim 9, wherein the act of determining comprises communicating the identifier to a workflow engine and receiving the workflow state from the workflow engine.

14. The method of claim 9, wherein the act of enabling comprises presenting a representation of the workflow state.

15. The method of claim 9, wherein the act of enabling comprises presenting a user interface enabling selection of workflow tasks.

16. The method of claim 15, further comprising receiving selection of a workflow task altering the workflow state and, responsive to that alteration, presenting a representation of the altered workflow state.

17. The method of claim 9, wherein the act of determining the workflow state comprises tailoring the workflow state to a user that opens the electronic file.

18. The method of claim 9, wherein the act of determining the workflow state comprises tailoring the workflow state to a user.

19. The method of claim 18, wherein the act of tailoring comprises filtering out parts of the workflow state that are not directly before or after tasks capable of altering the workflow state that can be performed by the user in the workflow.

20. The method of claim 18, wherein the act of tailoring comprises sending an identifier of the user to a workflow engine and receiving workflow tasks associated with the user.

21. The method of claim 9, further comprising receiving an interaction with the workflow that is capable of altering the workflow state.

22. The method of claim 21, further comprising updating the workflow state responsive to receiving the interaction.

23. The method of claim 9, wherein the act of enabling is performed in conjunction with a presentation of data of the electronic file.

24. The method of claim 9, wherein the act of enabling comprises presenting a graphical user interface enabling interaction with the workflow.

25. One or more computer-readable media having computer-readable instructions for performing the method recited in claim 9.

26. A system comprising means for performing the method recited in claim 9.

27. A method comprising:
receiving an identifier identifying an electronic file;
determining, responsive to receiving the identifier, a workflow state for the electronic file; and
presenting the workflow state in conjunction with a presentation of data of the electronic file.

28. The method of claim 27, wherein the act of receiving the identifier is performed responsive to the electronic file being opened.

29. The method of claim 27, wherein the act of receiving the identifier is performed responsive to receiving a selection to interact with the workflow through a user interface presenting the data.

30. The method of claim 27, wherein the act of determining comprises communicating the identifier to a workflow engine and receiving the workflow state from the workflow engine.

31. The method of claim 27, further comprising enabling selection of a workflow task capable of altering the workflow state.

32. The method of claim 31, further comprising receiving selection of the workflow task and, responsive to that selection, altering the presentation of the workflow state to reflect performance of the workflow task.

33. The method of claim 27, wherein the act of determining the workflow state comprises tailoring the workflow state to a user.

34. The method of claim 33, wherein the act of tailoring comprises sending an identifier of the user to a workflow engine, receiving workflow tasks associated with the user, and building the workflow state based on the received workflow tasks.

35. The method of claim 27, wherein the act of determining the workflow state comprises tailoring the workflow state to a user that opens the electronic file.

36. One or more computer-readable media having computer-readable instructions for performing the method recited in claim 27.

37. A system comprising means for performing the method recited in claim 27.

38. A method comprising:
providing an identifier having information sufficient to enable determination of a workflow governing an electronic file and a workflow state of the electronic file; and
associating the identifier with the electronic file.

39. The method of claim 38, wherein the act of associating comprises adding the identifier to the electronic file.

40. One or more computer-readable media having computer-readable instructions for performing the method recited in claim 38.

41. A system comprising means for performing the method recited in claim 38.

42. A computer-readable medium having an electronic file governed by a workflow and comprising an identifier capable of enabling determination of: the electronic file's workflow state in the workflow; and a portion of the workflow state associated with a user.

43. The electronic file of claim 42, wherein the identifier comprises a user identifier identifying the user and containing information sufficient for a workflow engine to determine the portion of the workflow state associated with the user.

44. The electronic file of claim 42, wherein the identifier contains information sufficient for a workflow engine to determine the workflow governing the electronic file and the workflow state for the electronic file.

45. The electronic file of claim 42, wherein the electronic file comprises extensible Markup Language (XML).
